(19) United States
(12) Patent Application Publication
(10) Pub. No.: US 2025/0304064 A1
(43) Pub. Date: Oct. 2, 2025

(54) CONTROL DEVICE AND METHOD FOR VEHICLE

(71) Applicants: HONDA MOTOR CO., LTD., Tokyo (JP); Hitachi Astemo, Ltd., Ibaraki (JP)

(72) Inventors: Fumiya Kobayashi, Tochigi (JP); Yuya Tanaka, Ibaraki (JP); Yoshitaka Fukasawa, Ibaraki (JP)

(21) Appl. No.: 19/090,681

(22) Filed: Mar. 26, 2025

(30) Foreign Application Priority Data
Mar. 29, 2024 (JP) 2024-056808

(51) Int. Cl. B60W 30/14

(52) U.S. Cl. CPC B60W 30/143; B60W 2420/408; B60W 2520/10

(57) ABSTRACT

A control device is provided in a vehicle having a radar device or a LiDAR which detects a plurality of external targets. The control device has a vehicle speed acquisition unit which acquires a vehicle speed detected by a vehicle speed sensor mounted on the vehicle, and a vehicle speed correction unit which corrects the vehicle speed based on a detection result of the radar device or the LiDAR. The vehicle speed correction unit acquires information on a plurality of stationary objects among the plurality of targets, based on the detection result of the radar device or the LiDAR, and corrects the vehicle speed based on relative speeds of the stationary objects relative to the vehicle, in a case where a predetermined condition is satisfied. The predetermined condition includes that the number of the stationary objects is equal to or greater than a predetermined number.

### CROSS-REFERENCE TO RELATED APPLICATIONS

This application is based on and claims priority under 35 USC 119 from Japanese Patent Application No. 2024-056808 filed on Mar. 29, 2024, the entire content of which is incorporated herein by reference.

### TECHNICAL FIELD

The present disclosure relates to a control device and a control method for a vehicle having a radar device or a LiDAR capable of detecting a plurality of external targets.

### BACKGROUND ART

In recent years, active efforts have been made to provide access to a sustainable transportation system in consideration of vulnerable people among traffic participants. For implementing the above object, research and development for further improving traffic safety and convenience through research and development related to driving assistance technology and preventive safety technology have been focused on. In the driving assistance technology and the preventive safety technology, it is desired to calculate a speed of a host vehicle with high accuracy in order to perform travel control of the vehicle accurately.

For example, JP6832166B describes a radar device that corrects a detected host vehicle speed, which is detected based on rotation of a wheel, based on a relative speed of a stationary object around the vehicle.

In the technique of correcting a detected vehicle speed based on relative speeds of stationary objects as in JP6832166B, a target moving at a low speed may be included in targets estimated as the stationary objects. In such a case, there is also room for improvement in that the vehicle speed can be calculated with high accuracy without reducing correction accuracy of the vehicle speed.

### SUMMARY OF INVENTION

The present disclosure provides a control device and a control method for a vehicle, which are capable of correcting a vehicle speed with high accuracy based on a relative speed of a stationary object detected by a radar device or LiDAR.

A first aspect of the present disclosure relates to a control device for a vehicle having a radar device or a LiDAR configured to detect a plurality of external targets, the control device including:
a vehicle speed acquisition unit configured to acquire a vehicle speed detected by a vehicle speed sensor mounted on the vehicle; and
a vehicle speed correction unit configured to correct the vehicle speed based on a detection result of the radar device or the LiDAR,
in which the vehicle speed correction unit is configured to:
   acquire information on a plurality of stationary objects estimated to be stationary among the plurality of targets, based on the detection result of the radar device or the LiDAR; and
   correct the vehicle speed based on relative speeds of the plurality of stationary objects relative to the vehicle detected by the radar device or the LiDAR, in a case where a predetermined condition is satisfied, and
the predetermined condition includes that a number of the stationary objects is equal to or greater than a predetermined number.

A second aspect of the present disclosure relates to a control method for a vehicle having a radar device or a LiDAR configured to detect a plurality of external targets, the control method causing a computer to perform:
acquiring a vehicle speed detected by a vehicle speed sensor mounted on the vehicle;
acquiring information on a plurality of stationary objects estimated to be stationary among the plurality of targets, based on a detection result of the radar device or the LiDAR;
determining whether a predetermined condition including that a number of the estimated stationary objects is equal to or greater than a predetermined number is satisfied; and
correcting the vehicle speed based on relative speeds of the plurality of stationary objects relative to the vehicle detected by the radar device or the LiDAR, in a case where the predetermined condition is satisfied.

According to the aspects of the present disclosure, the vehicle speed can be corrected with high accuracy based on the relative speeds of the stationary objects detected by the radar device or the LiDAR.

### BRIEF DESCRIPTION OF DRAWINGS

Exemplary embodiment(s) of the present invention will be described in detail based on the following figures, wherein:

FIG. 1 is a block diagram of a vehicle 1 having a control device 10 according to an embodiment of the present disclosure;

FIG. 2 is an example conceptually showing how a plurality of targets 100 in front of the vehicle 1 are detected by a radar device 33;

FIG. 3 is another example conceptually showing how the plurality of targets 100 (including moving targets) in front of the vehicle 1 are detected by the radar device 33;

FIG. 4 shows graphs each illustrating a variance of relative speeds of the plurality of stationary objects 110;

FIG. 5 is a flowchart showing an example of processing for correcting a detected vehicle speed; and

FIG. 6 is a flowchart showing an example of processing of correction condition determination.

### DESCRIPTION OF EMBODIMENTS

Hereinafter, an embodiment of a control device and a control method for a vehicle according to the present disclosure will be described with reference to the drawings.

A vehicle 1 according to an embodiment of the present disclosure is an automobile having a drive source, and wheels including drive wheels driven by power of the drive source and steered wheels that are steerable. As an example, the vehicle 1 may be a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or the four wheels including the pair of left and right front wheels and the pair of left and right rear wheels. The front wheels and the rear wheels of the vehicle 1 may all be steerable steered wheels, or the front wheels or the rear wheels may be steerable steered wheels.

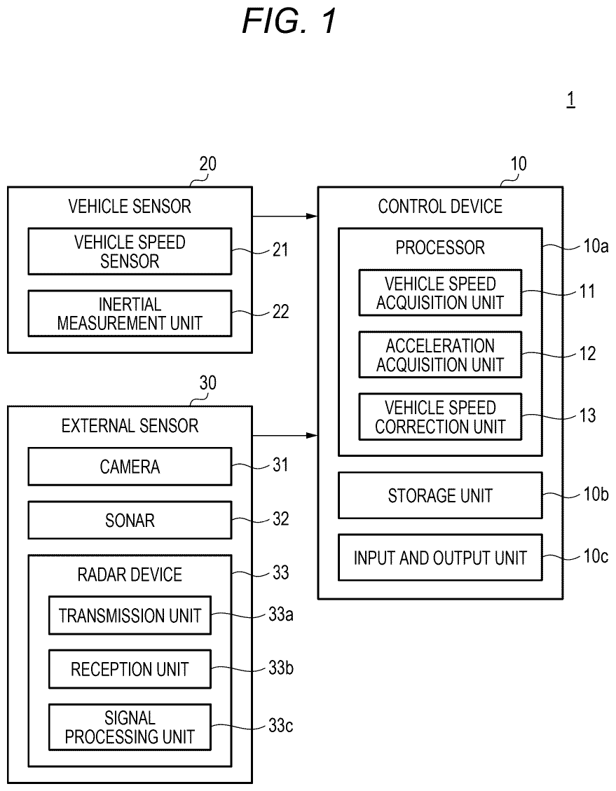

As shown in FIG. 1, the vehicle 1 has a control device 10, a vehicle sensor 20 that acquires information on the vehicle 1, and an external sensor 30 that acquires information on surroundings of the vehicle 1. Detection values detected by the vehicle sensor 20 and the external sensor 30 are output to the control device 10 and are used by the control device 10 to control the vehicle 1.

The vehicle sensor 20 includes, for example, a vehicle speed sensor 21 and an inertial measurement unit (IMU) 22.

The vehicle speed sensor 21 detects a vehicle speed that is a travel speed of the vehicle 1. For example, the vehicle speed sensor 21 detects the vehicle speed based on rotation of the wheels. The vehicle speed sensor 21 may detect the vehicle speed based on rotation of a counter shaft or the like in the vehicle 1.

The inertial measurement unit 22 detects angular velocities of the vehicle 1 in a pitch direction, a roll direction, and a yaw direction, and accelerations of the vehicle 1 in a front-rear direction, a left-right direction, and an upper-lower direction. The vehicle sensor 20 may include, instead of the inertial measurement unit 22, an acceleration sensor that detects an acceleration of the vehicle 1 in a predetermined direction and a gyro sensor that detects an angular velocity of the vehicle 1 in a predetermined direction.

The external sensor 30 includes, for example, a camera 31, a sonar 32, and a radar device 33.

The camera 31 images the surroundings of the vehicle 1 including a front side of the vehicle 1 and outputs image data of the obtained peripheral image to the control device 10. As the camera 31, for example, a digital camera using an imaging element such as a charge coupled device (CCD) or a complementary metal oxide semiconductor (CMOS) can be adopted.

The sonar 32 emits sound waves to the surroundings of the vehicle 1 (for example, the front, the rear, and lateral sides of the vehicle 1), and receives reflected sounds from a target present in the surroundings of the vehicle 1, thereby detecting a distance to the target, an azimuth of the target, and the like.

The radar device 33 includes a transmission unit 33a and a reception unit 33b including an antenna, emits radio waves to the surroundings of the vehicle 1 including the front side of the vehicle 1, and receives reflected waves from a target present in the surroundings of the vehicle 1. Accordingly, the radar device 33 detects the distance to the target, the azimuth of the target, and the like, and detects a relative speed of the target relative to the vehicle 1 based on a frequency of the reflected wave. As the radar device 33, for example, a millimeter wave radar can be adopted.

The radar device 33 includes a signal processing unit 33c that processes the received signal. The signal processing unit 33c includes, for example, a processor that performs various calculations, a storage device that stores various types of information, and an input and output unit that controls input and output of data.

The signal processing unit 33c of the radar device 33 specifies a target estimated to be stationary (hereinafter, also referred to as a stationary object) among a plurality of detected targets, based on the relative speed of the target. The stationary object is assumed to be various objects detected by the radar device 33, such as a parked vehicle, a utility pole installed on a roadside, and a signboard. The signal processing unit 33c calculates an absolute speed of the target based on the detected relative speed of the target and the vehicle speed detected by the vehicle speed sensor 21 (hereinafter, also referred to as a detected vehicle speed). When the absolute speed of the target is lower than a predetermined speed, the signal processing unit 33c estimates that the target is a stationary object and sets a stationary object flag to ON for the target, and when the absolute speed of the target is equal to or higher than the predetermined speed, the signal processing unit 33c estimates that the target is a moving object and sets the stationary object flag to OFF for the target.

The external sensor 30 may further include light detection and ranging (LiDAR). The LiDAR emits laser light to the surroundings of the vehicle 1 including the front side of the vehicle 1, and receives reflected light from a target present in the surroundings of the vehicle 1, thereby detecting a distance to the target, an azimuth of the target, a relative speed of the target relative to the vehicle 1, and the like. Further, the LiDAR specifies the stationary object estimated to be stationary among the plurality of targets, based on the relative speed of the target.

The control device 10 is, for example, a computer that includes a processor 10a for performing various calculations, a storage unit 10b including a non-transitory storage medium for storing various types of information, an input and output unit 10c for controlling input and output of data between an inside and an outside of the control device 10, and the like (not shown), and controls the entire vehicle 1. For example, the control device 10 is implemented by one electronic control unit (ECU) or by a plurality of ECUs working in cooperation with each other.

The control device 10 includes, for example, a vehicle speed acquisition unit 11, an acceleration acquisition unit 12, and a vehicle speed correction unit 13, as functional units implemented by the processor 10a executing a program stored in the storage unit 10b.

The vehicle speed acquisition unit 11 receives a signal from the vehicle speed sensor 21 and acquires the detected vehicle speed of the vehicle 1. The acceleration acquisition unit 12 receives a signal from the inertial measurement unit 22 and acquires acceleration in each direction of the vehicle 1. The vehicle speed acquisition unit 11 may be configured to acquire the vehicle speed of the vehicle 1 as the detected vehicle speed based on the signal from the vehicle speed sensor 21 and the signal from the inertial measurement unit 22.

The vehicle speed correction unit 13 corrects the detected vehicle speed acquired by the vehicle speed acquisition unit 11 when a predetermined correction condition to be described later is satisfied. Since the detected vehicle speed includes an error with respect to an actual vehicle speed when a diameter of the wheel changes due to a change in air pressure of a tire, wear, or the like, the error between the detected vehicle speed and the actual vehicle speed is reduced by correction of the vehicle speed correction unit 13.

The vehicle speed correction unit 13 calculates a correction value based on the detected vehicle speed and the relative speeds of the plurality of stationary objects detected by the radar device 33, and corrects the detected vehicle speed based on the correction value. The correction value is, for example, a correction factor that is a value obtained by dividing an average value of the relative speeds of the plurality of stationary objects by the detected vehicle speed.

Since the detected vehicle speed can be brought close to the actual vehicle speed by the correction, for example, accuracy and reliability of the travel control related to driving assistance including automated driving of the vehicle 1 (autonomous travel of the vehicle 1 without operation of a driver) are improved. The driving assistance includes, for example, collision mitigation brake control system (CMBS) that supports, when a probability of a collision with an object ahead increases, avoidance and mitigation of a collision between the vehicle 1 and the object.

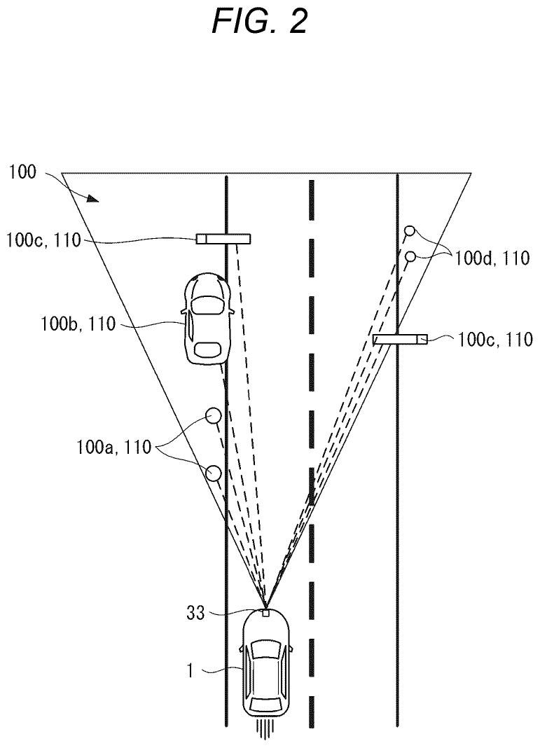

FIG. 2 is an example conceptually showing how a plurality of targets 100 in front of the vehicle 1 are detected by the radar device 33. In the shown example, the radar device 33 is attached to a central front portion of the vehicle 1, but is not limited thereto, and may be attached to the vehicle 1 at any position as long as the radar device 33 can emit radio waves to the front side of the vehicle 1.

The radar device 33 detects the plurality of targets 100 in front of the vehicle 1 by emitting radio waves to the front side of the vehicle 1 and receiving reflected waves from objects present in the surroundings. The radar device 33 estimates targets estimated to be stationary as stationary objects 110 based on the relative speeds of the targets 100 and the detected vehicle speed, and sets the stationary object flag to ON for each of the stationary objects 110.

In the example shown in FIG. 2, the radar device 33 detects utility poles 100a, a parked vehicle 100b, signboards 100c, and poles 100d present in front of the vehicle 1 as the targets 100. Then, the radar device 33 calculates the absolute speed of each target 100 based on the relative speed of each target 100 and the detected vehicle speed. Since the utility poles 100a, the parked vehicle 100b, the signboards 100c, and the poles 100d are completely stationary targets 100, and the calculated absolute speed of each target 100 is lower than the predetermined speed described above, the radar device 33 estimates these targets 100 as the stationary objects 110. FIG. 2 shows a case where the utility poles 100a, the parked vehicle 100b, the signboards 100c, and the poles 100d are present in front of the vehicle 1 as the plurality of targets 100, but actually, many objects including a moving object (not shown) and other stationary objects are present and detected by the radar device 33.

The control device 10 acquires information on the plurality of targets 100 from the radar device 33. Specifically, the control device 10 acquires, from the radar device 33, information such as a distance, an azimuth, and a relative speed between the vehicle 1 and each target 100, and information such as the stationary object flag of each target 100. Accordingly, the control device 10 recognizes the presence of the plurality of targets 100 detected by the radar device 33 and the stationary objects 110 included in the plurality of targets 100.

Then, the control device 10 corrects the detected vehicle speed based on the relative speeds of the stationary objects 110 relative to the vehicle 1 and the detected vehicle speed. When the stationary object 110 is a completely stationary object, the relative speed of the stationary object 110 takes a value close to the actual vehicle speed of the vehicle 1.

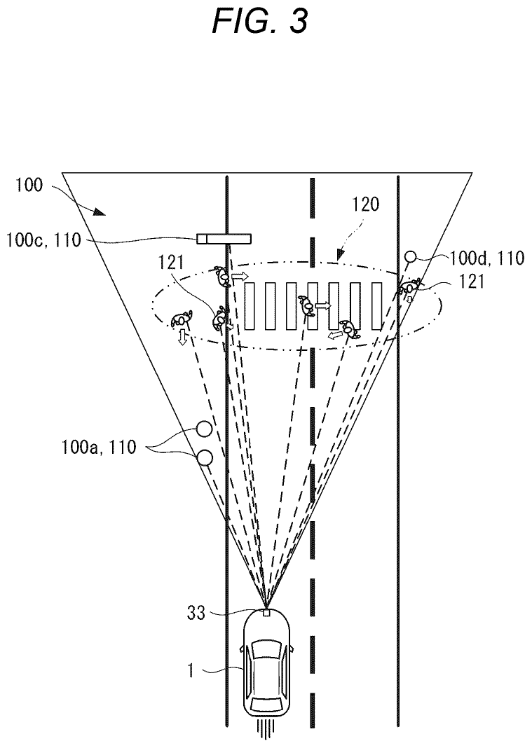

FIG. 3 is another example conceptually showing how the plurality of targets 100 in front of the vehicle 1 are detected by the radar device 33. FIG. 3 shows a case where a plurality of pedestrians 120 (an example of the target 100 that is moving) are present in front of the vehicle 1.

Similar to the case of FIG. 2, the radar device 33 estimates the utility poles 100a, the signboard 100c, and the pole 100d present in front of the vehicle 1 as the stationary objects 110, and sets the stationary object flags thereof to ON. On the other hand, the radar device 33 estimates the plurality of pedestrians 120 who are walking to be moving objects, and sets the stationary object flag of each of the pedestrians 120 to OFF.

However, for example, for the pedestrian 121 who is walking at a low speed among the plurality of pedestrians 120, the radar device 33 may estimate the pedestrian 121 to be the stationary object 110 and set the stationary object flag of the pedestrian 121 to ON. In other words, the stationary objects 110 estimated based on the detection result of the radar device 33 may include moving targets (here, the pedestrians 121) in addition to the completely stationary targets. Since the detected vehicle speed is corrected by the control device 10 based on the relative speed of the stationary object 110 as described above, it is required that the vehicle speed can be calculated with high accuracy without lowering the correction accuracy of the detected vehicle speed even when moving targets are included in the stationary objects 110.

In the present embodiment, the control device 10 corrects the vehicle speed when the predetermined correction condition is satisfied. Specifically, the correction condition includes that the number of the estimated stationary objects 110 is equal to or greater than a predetermined number (for example, equal to or greater than 10). When the number of the estimated stationary objects 110 is equal to or greater than the predetermined number, the control device 10 corrects the detected vehicle speed based on the relative speeds of the plurality of stationary objects 110. In other words, the control device 10 does not correct the detected vehicle speed when the number of the estimated stationary objects 110 is less than the predetermined number.

According to such a configuration, even if the moving targets (for example, the pedestrians 121) are included in the plurality of estimated stationary objects 110, an influence of the moving targets is relatively reduced due to the presence of the plurality of stationary objects 110 that are completely stationary. Therefore, a decrease in the correction accuracy of the detected vehicle speed can be prevented and the vehicle speed can be corrected with high accuracy. Further, since the detected vehicle speed is not corrected when the number of the estimated stationary objects 110 is less than the predetermined number, it is possible to avoid performing correction with low accuracy.

Further, even when no moving target is included in the plurality of estimated stationary objects 110, the detected relative speed may vary due to a difference in the distance between each stationary object 110 and the vehicle 1, and the correction accuracy of the detected vehicle speed may decrease. Since the control device 10 of the present embodiment corrects the detected vehicle speed when the number of the estimated stationary objects 110 is equal to or greater than the predetermined number, such a decrease in the correction accuracy can be prevented and the vehicle speed can be corrected with high accuracy. Therefore, reliability of the driving assistance technology can be improved by increasing accuracy of information on the vehicle speed of the vehicle 1 used for travel control of the driving assistance technology.

In order to improve the correction accuracy of the detected vehicle speed, the above-described correction condition preferably further includes a condition in addition to the number of the estimated stationary objects 110 being equal to or greater than the predetermined number.

For example, the correction condition preferably further includes that a variance of the relative speeds of the plurality of stationary objects 110 is less than a predetermined value.

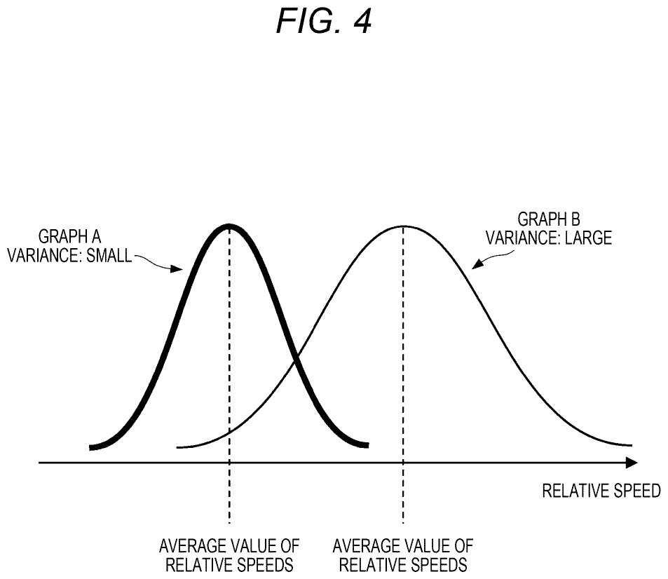

FIG. 4 shows graphs each illustrating the variance of the relative speeds of the plurality of stationary objects 110, and shows a distribution of the relative speeds of the plurality of stationary objects 110. In a graph A (thick solid line), the distribution of the detected stationary objects 110 is narrow, and the relative speeds of the stationary objects 110 are concentrated in the vicinity of an average value. That is, the graph A is a graph in which the variance of the relative speeds is small. The graph A corresponds to a case where no moving target is included in the targets estimated to be the stationary objects 110, or a case where the number of targets included is small. On the other hand, in a graph B (thin solid line), the distribution of the detected stationary objects 110 is wide. That is, the graph B is a graph in which the variance of the relative speeds is large. The graph B corresponds to a case where more moving targets are included in the targets estimated to be the stationary objects 110 than in the graph A.

When a case where a detection result having a small variance such as the graph A is obtained by the radar device 33 and a case where a detection result having a large variance such as the graph B is obtained are compared, it is considered that the graph A has a lower ratio at which moving targets are included in the targets estimated to be the stationary objects 110. Therefore, it is preferable that the control device 10 corrects the vehicle speed when a detection result having a small variance as in the graph A is obtained. Further, it is preferable that the control device 10 does not correct the vehicle speed when a detection result having a large variance as in the graph B is obtained. According to such a configuration, a decrease in the correction accuracy of the vehicle speed can be more reliably prevented. In the above correction condition, instead of the variance of the relative speeds, a standard deviation of the relative speed may be less than a predetermined value.

Further, it is preferable that the correction condition further includes that a state where the number of the estimated stationary objects 110 is equal to or greater than the predetermined number continues for a predetermined time or longer. Since the vehicle speed is corrected when the stationary object 110 is stably detected, the correction accuracy of the vehicle speed is improved.

Further, it is preferable that the correction condition further includes that the estimated stationary object 110 is detected by the radar device 33 while the vehicle 1 travels straight. The relative speeds of the targets 100 detected while the vehicle 1 travels straight are higher in detection accuracy than the relative speeds of the targets 100 detected by the radar device 33 while the vehicle 1 travels on a curve or turning right or left. When the correction condition is satisfied, the detection accuracy of the relative speed of the stationary object 110 increases, and as a result, the correction accuracy of the vehicle speed is improved.

Further, it is preferable that the correction condition further includes that the estimated stationary object 110 is detected by the radar device 33 while the vehicle 1 travels at a first speed (for example, 5 km/h) or higher. When the vehicle 1 travels at a low speed, since a detection error of the relative speed of the target 100 may increase relatively, a lower limit value of the travel speed (that is, the first speed) is preferably included in the correction condition. When the correction condition is satisfied, the detection accuracy of the relative speed of the stationary object 110 increases, and as a result, the correction accuracy of the vehicle speed is improved. The first speed may be variably set depending on a travel condition of the vehicle 1 (a width of the road, whether a pedestrian is detected, or the like).

Further, it is preferable that the correction condition further includes that the estimated stationary object 110 is detected by the radar device 33 while the vehicle 1 travels at a predetermined acceleration or less. The acceleration here is, for example, a forward-rearward acceleration and/or a lateral acceleration of the vehicle 1, and it is determined whether a forward-rearward acceleration and/or lateral acceleration detected by the inertial measurement unit 22 is equal to or less than a predetermined acceleration. The relative speeds of the stationary objects 110 detected by the radar device 33 have higher detection accuracy when a change in the vehicle speed is small than when the change in the vehicle speed is large. Therefore, when the correction condition is satisfied, the detection accuracy of the relative speed of the stationary object 110 increases, and as a result, the correction accuracy of the vehicle speed is improved.

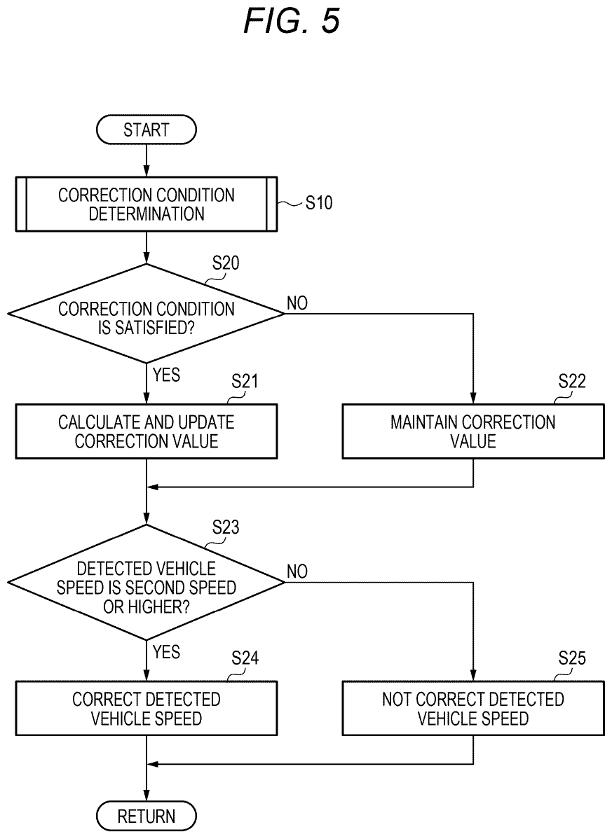

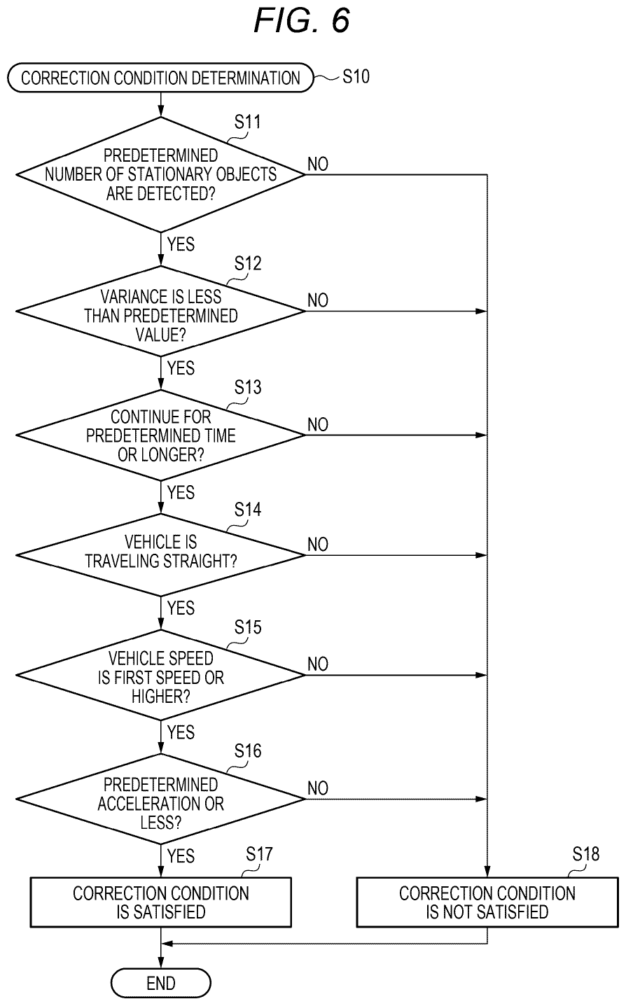

FIG. 5 is a flowchart showing an example of processing for correcting the detected vehicle speed by the control device 10, and FIG. 6 is a flowchart showing an example of processing of correction condition determination. The control device 10 executes the flowchart of FIG. 5 at predetermined time intervals.

As shown in FIG. 5, the control device 10 first performs the correction condition determination (step S10). The correction condition determination is performed based on the flowchart of FIG. 6.

As shown in FIG. 6, in the correction condition determination, the control device 10 determines whether the various conditions included in the above-described correction condition are satisfied (steps S11 to S16). When all the various conditions included in the above-described correction condition are satisfied (steps S11 to S16: YES), the control device 10 determines that the correction condition is satisfied (step S17). On the other hand, when at least one of the various conditions included in the correction condition is not satisfied (NO in at least one of steps S11 to S16), the control device 10 determines that the correction condition is not satisfied (step S18).

The order of steps S11 to S16 is not limited thereto, and the order can be freely set. In the correction condition determination, it is not necessary to include all of steps S11 to S16, and any step may be omitted or another step may be added.

Returning to FIG. 5, after the correction condition determination is performed (step S10), the control device 10 determines whether the correction condition is satisfied (step S20). When the correction condition is satisfied (step S20: YES), the control device 10 calculates and updates the correction value (step S21). Specifically, the control device 10 updates, when the correction value calculated at the time of execution of the previous flowchart or the like is already set, the calculated correction value to a new value in step S21, and sets, when the correction value is not set (or zero), the correction value in step S21.

When the correction condition is not satisfied (step S20: NO), the control device 10 maintains the correction value (step S22). Specifically, the control device 10 maintains, when the correction value calculated at the time of execution of the previous flowchart or the like is already set, the correction value in step S22, and does not set, when the correction value is not set (or zero), the correction value in step S22.

In step S21, when the calculated correction value is outside a predetermined range, the control device 10 preferably limits the correction value. Specifically, when the correction factor, which is an example of the correction value, is outside a range of −5% to +5%, the corrected vehicle speed may greatly deviate from the detected vehicle speed, and thus the control device 10 limits the correction factor. For example, when the correction factor is greater than +5%, the control device 10 sets the correction factor to +5%. In other words, +5% is an upper limit value of the correction factor. When the correction factor is less than −5%, the control device 10 sets the correction factor to −5%. In other words, −5% is a lower limit value of the correction factor. According to such a configuration, the corrected vehicle speed can be prevented from being set excessively high or low.

The control device 10 may be configured to limit the corrected vehicle speed when the corrected vehicle speed is outside a predetermined range. Specifically, when a difference between the corrected vehicle speed and the detected vehicle speed is equal to or greater than a predetermined value, the corrected vehicle speed may greatly deviate from the detected vehicle speed, and thus the control device 10 limits the corrected vehicle speed. For example, when the difference between the corrected vehicle speed and the detected vehicle speed is equal to or greater than a predetermined value, the control device 10 sets the corrected vehicle speed to a predetermined upper limit value or lower limit value.

After step S21 or S22, the control device 10 determines whether the detected vehicle speed is equal to or higher than a second speed (step S23). The second speed is about the same as the first speed or is a speed lower than the first speed.

Since the deviation between the detected vehicle speed and the actual vehicle speed is relatively small when the vehicle 1 travels at a low speed, the control device 10 does not correct the detected vehicle speed regardless of whether the correction condition is satisfied when the detected vehicle speed is lower than the second speed (step S25). Accordingly, excessive correction of the detected vehicle speed can be prevented. Since the deviation between the detected vehicle speed and the actual vehicle speed increases when the travel speed of the vehicle 1 increases, the control device 10 corrects the detected vehicle speed when the detected vehicle speed is equal to or higher than the second speed (step S24).

In the present embodiment, during a period over which an ignition of the vehicle 1 is set from an ON state to an OFF state, the control device 10 maintains the correction value calculated in step S21 in the storage unit 10b until the next correction condition is satisfied. Accordingly, since the highly accurate correction value calculated in step S21 is maintained while the ignition is in the ON state, the reliability of the driving assistance technology can be improved.

The control method described in the above embodiment may be implemented by executing a control program prepared in advance on a computer. The control program is stored in a computer-readable storage medium and executed by being read from the storage medium. Further, the control program may be provided in a form stored in a non-transitory storage medium such as a flash memory, or may be provided via a network such as the Internet. The computer that executes the control program may be provided in the control device 10 or may be provided in the radar device 33. The computer that executes the control program may be provided in an electronic device such as a smartphone, a tablet terminal, or a personal computer that can communicate with the control device 10 and/or the radar device 33, or may be provided in a server device that can communicate with the control device 10 and the radar device 33.

Although an embodiment of the present disclosure has been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

For example, in the above embodiment, the correction of the detected vehicle speed based on the target 100 detected by the radar device 33 has been described, but the present disclosure is not limited thereto. The control device 10 may be configured to correct the detected vehicle speed based on the target detected by the LiDAR.

In the above embodiment, a configuration in which the signal processing unit 33c of the radar device 33 detects the relative speed of the target and estimates whether the target is a stationary object has been described, but the present invention is not limited thereto. A function corresponding to the signal processing unit 33c may be provided in the control device 10. In other words, the control device 10 may be configured to estimate whether the target detected by the radar device 33 is a stationary object based on the detection result of the radar device 33.

In the above embodiment, the correction value or the corrected vehicle speed is limited in step S21, but instead of this, the corrected vehicle speed being within a predetermined range with respect to the detected vehicle speed, or the correction value being within a predetermined range may be added to the correction condition. According to such a configuration, the vehicle speed is not corrected when the correction accuracy of the vehicle speed is low and the corrected vehicle speed may be set excessively high or low.

In the present description, at least the following matters are described. In the parentheses, the corresponding constituent elements and the like in the above embodiment are shown as examples, but the present invention is not limited thereto.

(1) A control device (control device 10) for a vehicle (vehicle 1) having a radar device (radar device 33) or a LiDAR configured to detect a plurality of external targets (targets 100), the control device including:
a vehicle speed acquisition unit (vehicle speed acquisition unit 11) configured to acquire a vehicle speed detected by a vehicle speed sensor (vehicle speed sensor 21) mounted on the vehicle; and
a vehicle speed correction unit (vehicle speed correction unit 13) configured to correct the vehicle speed based on a detection result of the radar device or the LiDAR,
in which the vehicle speed correction unit is configured to:
   acquire information on a plurality of stationary objects (stationary objects 110) estimated to be stationary among the plurality of targets, based on the detection result of the radar device or the LiDAR; and
   correct the vehicle speed based on relative speeds of the plurality of stationary objects relative to the vehicle detected by the radar device or the LiDAR, in a case where a predetermined condition is satisfied, and
the predetermined condition includes that a number of the stationary objects is equal to or greater than a predetermined number.

According to (1), when the number of the estimated stationary objects is equal to or greater than the predetermined number, even if a moving target is estimated to be the stationary object, an influence of the moving target is relatively reduced due to the presence of other stationary objects that are completely stationary. Accordingly, a decrease in correction accuracy of the vehicle speed can be prevented, and the vehicle speed can be corrected with high accuracy. Therefore, reliability of the driving assistance technology can be improved by increasing accuracy of information on the vehicle speed used for travel control of the driving assistance technology.

(2) The control device for the vehicle according to (1),
in which the vehicle speed correction unit is configured to calculate a variance or a standard deviation of the relative speeds of the plurality of stationary objects, and
the predetermined condition further includes that the variance or the standard deviation is less than a predetermined value.

According to (2), the vehicle speed is corrected when a ratio of the moving target included in the targets estimated to be the stationary objects is low. Further, the vehicle speed is not corrected when the ratio of the moving target included in the targets estimated to be the stationary objects is high. Therefore, the decrease in the correction accuracy of the vehicle speed can be reliably prevented.

(3) The control device for the vehicle according to (1) or (2),
in which the predetermined condition further includes that a state where the number of the stationary objects is equal to or greater than the predetermined number continues for a predetermined time or longer.

According to (3), since the vehicle speed is corrected when the stationary objects are stably detected, the correction accuracy of the vehicle speed is improved.

(4) The control device for the vehicle according to (1) or (2),
in which the predetermined condition further includes that the plurality of stationary objects are detected by the radar device or the LiDAR while the vehicle travels straight.

According to (4), the relative speeds acquired from the stationary objects detected while the vehicle travels straight are higher in detection accuracy than the relative speeds acquired from the stationary objects detected while the vehicle travels on a curve or the like. Therefore, detection accuracy of the relative speeds of the stationary objects is improved, and as a result, the correction accuracy of the vehicle speed is improved.

(5) The control device for the vehicle according to (1) or (2),
in which the predetermined condition further includes that the plurality of stationary objects are detected by the radar device or the LiDAR while the vehicle travels at a first speed or higher.

According to (5), since the vehicle travels at the first speed or higher, a detection error of the relative speeds of the stationary objects is reduced relatively, and detection accuracy of the stationary objects is increased. As a result, the correction accuracy of the vehicle speed is improved.

(6) The control device for the vehicle according to (1) or (2),
in which the predetermined condition further includes that the plurality of stationary objects are detected by the radar device or the LiDAR while the vehicle travels at a predetermined acceleration or less.

According to (6), since the relative speeds acquired from the stationary objects detected when a change in the vehicle speed is small have higher detection accuracy than the relative speeds acquired from the stationary objects detected when the change in the vehicle speed is large, the correction accuracy of the vehicle speed is improved.

(7) The control device for the vehicle according to (1) or (2),
in which the vehicle speed correction unit is configured to:
   calculate a correction value based on the relative speeds in the case where the predetermined condition is satisfied; and
   limit the correction value or a corrected vehicle speed, in a case where the calculated correction value is outside a predetermined range or in a case where the corrected vehicle speed is outside a predetermined range with respect to the vehicle speed acquired by the vehicle speed acquisition unit.

According to (7), since the correction value or the corrected vehicle speed is limited when the corrected vehicle speed greatly deviates from the vehicle speed acquired by the vehicle speed acquisition unit, the corrected vehicle speed can be prevented from being set excessively high or low.

(8) The control device for the vehicle according to (1) or (2),
in which the predetermined condition further includes that a corrected vehicle speed calculated by the vehicle speed correction unit is within a predetermined range with respect to the vehicle speed acquired by the vehicle speed acquisition unit, or that a correction value calculated by the vehicle speed correction unit is within a predetermined range.

According to (8), when the correction accuracy of the vehicle speed is low and the corrected vehicle speed may be set excessively high or low, it is possible to avoid performing the correction of the vehicle speed.

(9) The control device for the vehicle according to (1) or (2),
in which the vehicle speed correction unit is configured to:
   calculate a correction value based on the relative speeds, in the case where the predetermined condition is satisfied, to correct the vehicle speed based on the correction value; and
   maintain the correction value until the predetermined condition is satisfied next time after the calculation of the correction value, during a period over which an ignition of the vehicle is set from an ON state to an OFF state.

According to (9), since the highly accurate correction value is maintained while the ignition is in the ON state, the reliability of the driving assistance technology can be improved.

(10) A control method for a vehicle (vehicle 1) having a radar device (radar device 33) or a LiDAR configured to detect a plurality of external targets (targets 100), the control method causing a computer to perform:
acquiring a vehicle speed detected by a vehicle speed sensor (vehicle speed sensor 21) mounted on the vehicle;
acquiring information on a plurality of stationary objects (stationary objects 110) estimated to be stationary among the plurality of targets, based on a detection result of the radar device or the LiDAR;
determining whether a predetermined condition including that a number of the estimated stationary objects is equal to or greater than a predetermined number is satisfied; and
correcting the vehicle speed based on relative speeds of the plurality of stationary objects relative to the vehicle detected by the radar device or the LiDAR, in a case where the predetermined condition is satisfied.

According to (10), when the number of the estimated stationary objects is equal to or greater than the predetermined number, even if a moving target is estimated to be the stationary object, the influence of the moving target is relatively reduced due to the presence of other stationary objects that are completely stationary. Accordingly, the decrease in the correction accuracy of the vehicle speed can be prevented, and the vehicle speed can be corrected with high accuracy. Therefore, the reliability of the driving assistance technology can be improved by increasing the accuracy of the information on the vehicle speed used for the travel control of the driving assistance technology.

What is claimed is:

1. A control device for a vehicle having a radar device or a LiDAR configured to detect a plurality of external targets, the control device comprising:
a vehicle speed acquisition unit configured to acquire a vehicle speed detected by a vehicle speed sensor mounted on the vehicle; and
a vehicle speed correction unit configured to correct the vehicle speed based on a detection result of the radar device or the LiDAR,
wherein the vehicle speed correction unit is configured to:
acquire information on a plurality of stationary objects estimated to be stationary among the plurality of targets, based on the detection result of the radar device or the LiDAR; and
correct the vehicle speed based on relative speeds of the plurality of stationary objects relative to the vehicle detected by the radar device or the LiDAR, in a case where a predetermined condition is satisfied, and
the predetermined condition includes that a number of the stationary objects is equal to or greater than a predetermined number.

2. The control device for the vehicle according to claim 1,
wherein the vehicle speed correction unit is configured to calculate a variance or a standard deviation of the relative speeds of the plurality of stationary objects, and
the predetermined condition further includes that the variance or the standard deviation is less than a predetermined value.

3. The control device for the vehicle according to claim 1,
wherein the predetermined condition further includes that a state where the number of the stationary objects is equal to or greater than the predetermined number continues for a predetermined time or longer.

4. The control device for the vehicle according to claim 1,
wherein the predetermined condition further includes that the plurality of stationary objects are detected by the radar device or the LiDAR while the vehicle travels straight.

5. The control device for the vehicle according to claim 1,
wherein the predetermined condition further includes that the plurality of stationary objects are detected by the radar device or the LiDAR while the vehicle travels at a first speed or higher.

6. The control device for the vehicle according to claim 1,
wherein the predetermined condition further includes that the plurality of stationary objects are detected by the radar device or the LiDAR while the vehicle travels at a predetermined acceleration or less.

7. The control device for the vehicle according to claim 1,
wherein the vehicle speed correction unit is configured to:
calculate a correction value based on the relative speeds in the case where the predetermined condition is satisfied; and
limit the correction value or a corrected vehicle speed, in a case where the calculated correction value is outside a predetermined range or in a case where the corrected vehicle speed is outside a predetermined range with respect to the vehicle speed acquired by the vehicle speed acquisition unit.

8. The control device for the vehicle according to claim 1,
wherein the predetermined condition further includes that a corrected vehicle speed calculated by the vehicle speed correction unit is within a predetermined range with respect to the vehicle speed acquired by the vehicle speed acquisition unit, or that a correction value calculated by the vehicle speed correction unit is within a predetermined range.

9. The control device for the vehicle according to claim 1,
wherein the vehicle speed correction unit is configured to:
calculate a correction value based on the relative speeds, in the case where the predetermined condition is satisfied, to correct the vehicle speed based on the correction value; and
maintain the correction value until the predetermined condition is satisfied next time after the calculation of the correction value, during a period over which an ignition of the vehicle is set from an ON state to an OFF state.

10. A control method for a vehicle having a radar device or a LiDAR configured to detect a plurality of external targets, the control method causing a computer to perform:
acquiring a vehicle speed detected by a vehicle speed sensor mounted on the vehicle;
acquiring information on a plurality of stationary objects estimated to be stationary among the plurality of targets, based on a detection result of the radar device or the LiDAR;
determining whether a predetermined condition including that a number of the estimated stationary objects is equal to or greater than a predetermined number is satisfied; and
correcting the vehicle speed based on relative speeds of the plurality of stationary objects relative to the vehicle detected by the radar device or the LiDAR, in a case where the predetermined condition is satisfied.
